(19) United States
(12) Patent Application Publication
(10) Pub. No.: US 2010/0326232 A1
(43) Pub. Date: Dec. 30, 2010

(54) Supplemental set of handlebars for bicycle

(76) Inventor: Ming-Jen Wang, Changhua (TW)

Correspondence Address: SAM CHEN, 7F-1, 293, ROOSEVELT ROAD, SEC 3, TAIPEI, TW

(21) Appl. No.: 12/490,330

(22) Filed: Jun. 24, 2009

(51) Int. Cl. B62K 21/16

(52) U.S. Cl. 74/551.3

(57) ABSTRACT

A steering system for a bicycle includes a steering post; a primary set of handlebars secured to the steering post; and a supplemental set of handlebars comprising a plate including two forward opposite extensions each having at least one groove, and two rear wings; a U-shaped handle element adjustably secured to the at least one groove by threading; and a clamp for securing the plate to the primary set of handlebars. A bicycle rider may rest the elbows on the wings with the hands gripping the handle element in a relatively comfortable riding manner.

### BACKGROUND OF THE INVENTION

1. Field of Invention

The invention relates to bicycle handlebars and more particularly to a set of supplemental handlebars mounted on a set of primary handlebars of a bicycle (e.g., racing bicycle) so that a bicycle rider's hands may rest upon the set of supplemental handlebars while riding.

2. Description of Related Art

For a racing bicycle, a person riding the bicycle may bend greatly at the waste to reach the handlebars. This puts the riders in an aerodynamic racing position. But this rider position is not comfortable and can cause fatigue quickly. Hence, such bending posture of the rider cannot last for a relatively long period of riding time. Therefore, a type of racing bicycle having an additional set of supplemental handlebars mounted on a set of primary handlebars thereof is commercially available. A rider may rest his/her hands on the set of supplemental handlebars when riding.

There have been numerous suggestions in prior patents for supplemental set of handlebars for bicycle. For example, U.S. Pat. No. 6,662,680 discloses device and method for attaching a supplemental set of handlebars to a bicycle. Thus, continuing improvements in the exploitation of supplemental set of handlebars for bicycle are constantly being sought.

### SUMMARY OF THE INVENTION

It is therefore one object of the invention to provide a set of supplemental handlebars mounted on a set of primary handlebars of a bicycle so that a bicycle rider's hands may rest upon the set of supplemental handlebars while riding.

The above and other objects, features and advantages of the invention will become apparent from the following detailed description taken with the accompanying drawings.

### BRIEF DESCRIPTION OF THE DRAWINGS

FIG. 1 is an exploded perspective view of a preferred embodiment of supplemental set of handlebars for bicycle according to the invention;

FIG. 2 is a perspective view of the assembled supplemental set of handlebars of FIG. 1;

FIGS. 3 and 4 are top plan views of FIG. 2 showing length increase and decrease adjustments of the supplemental set of handlebars respectively; and

FIG. 5 is a side elevation of a segment of bicycle showing the set of supplemental handlebars mounted on the set of primary handlebars of the bicycle.

### DETAILED DESCRIPTION OF THE INVENTION

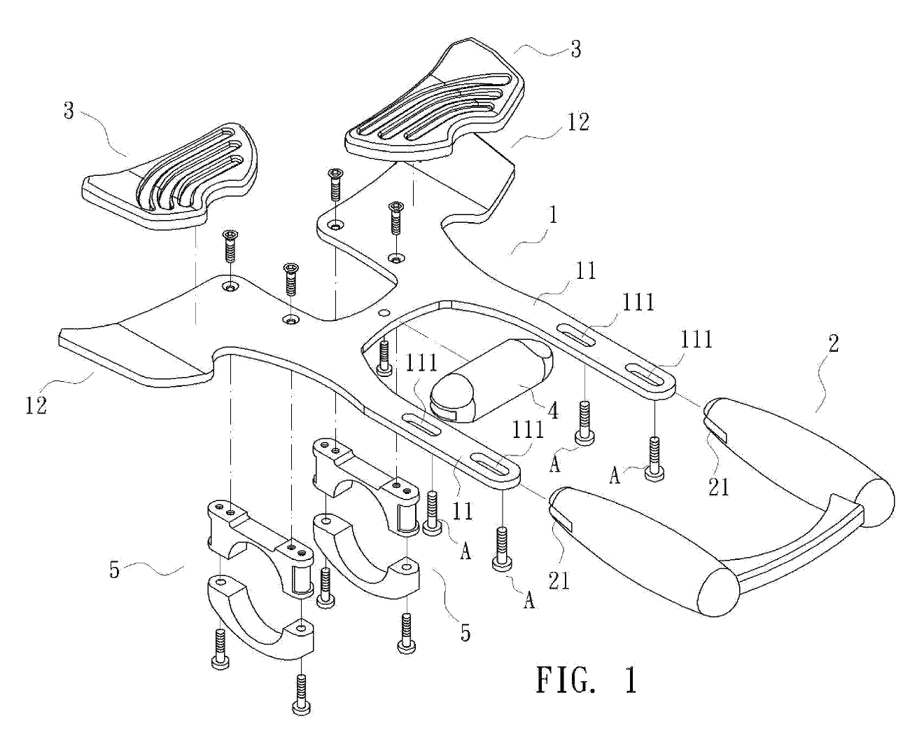

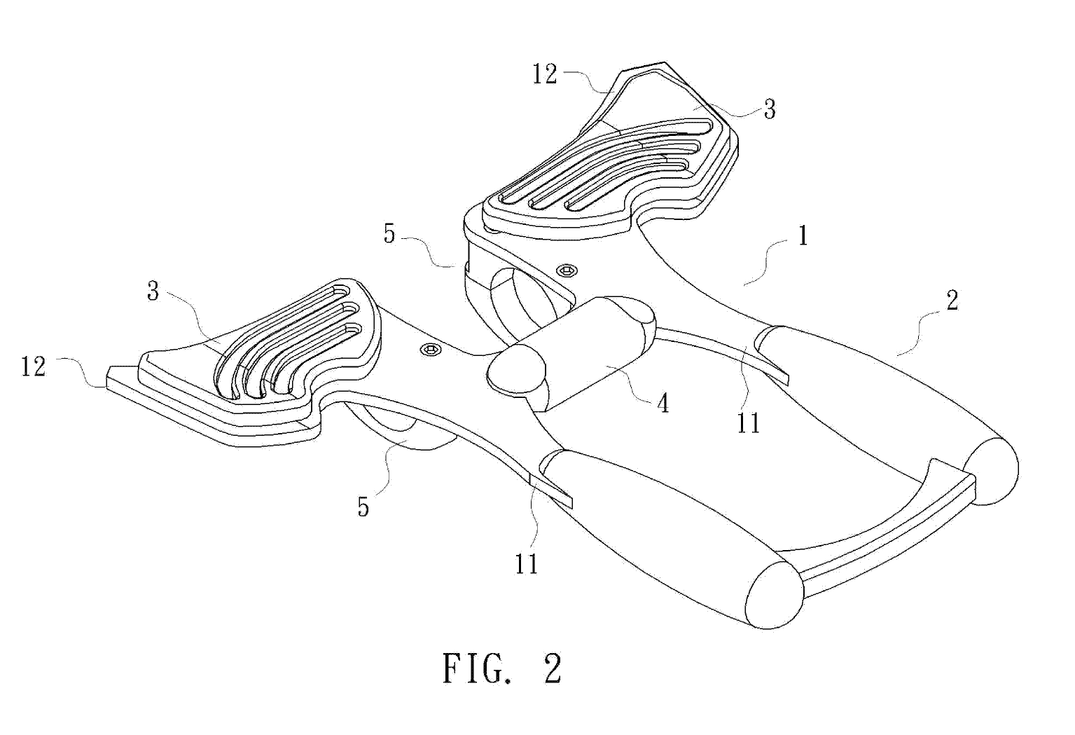

Referring to FIGS. 1 to 5, a supplemental set of handlebars for a bicycle 6 in accordance with a preferred embodiment of the invention comprises the following components as discussed in detail below.

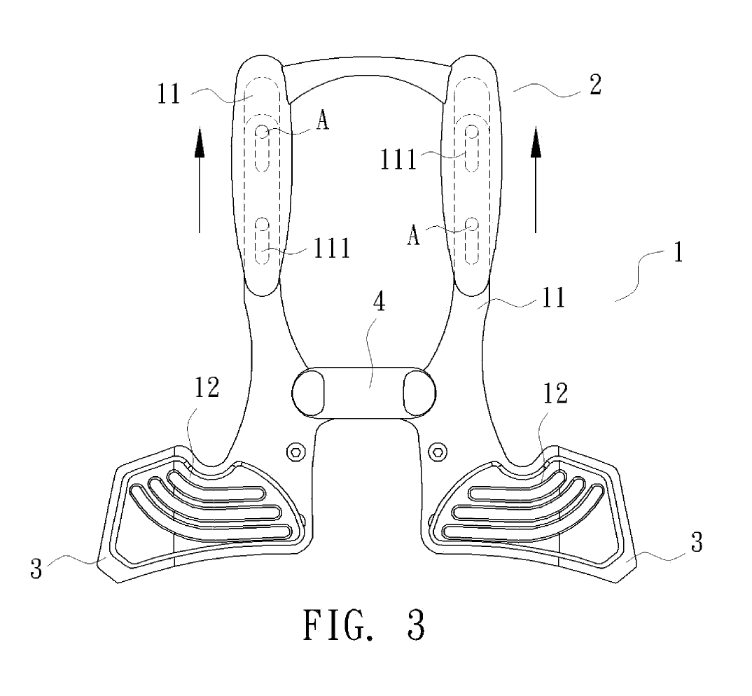

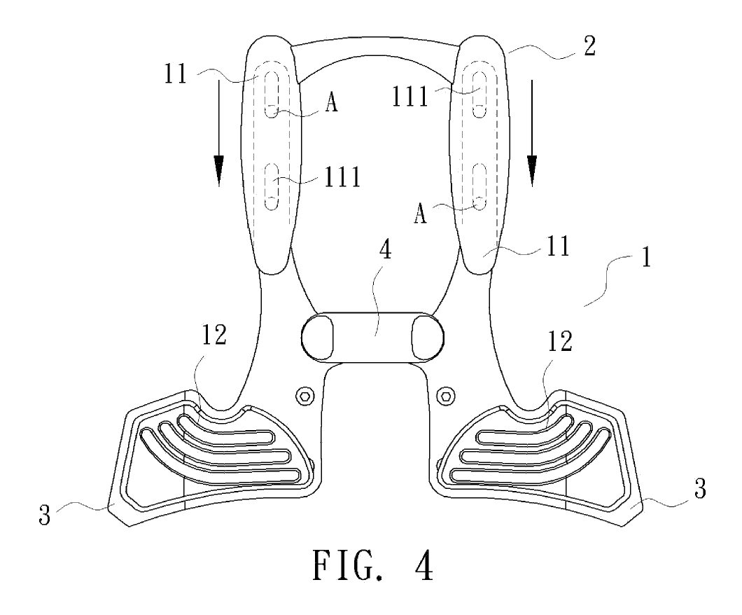

A substantially H-shaped plate 1 comprises two forward opposite extensions 11 each having two spaced grooves 111; and two rear wings 12. Two pads 3 each is provided on the wing 12. A U-shaped handle element 2 has two channels 21 in both side sections. The channel 21 has a rear opening and the extensions 11 are adapted to insert into the channels 21 through the rear openings of the channel 21. A plurality of screws A are driven through the channels 21 and the grooves 111 to secure the handle element 2 to the plate 1. The fastening of the handle element 2 and the plate 1 is adjustable by driving the screws A into selected points along the lengths of the grooves 111. Hence, the total length of the handle element 2 and the plate 1 is adjustable (see FIGS. 3 and 4). A speedometer seat 4 is threadedly secured to an interconnection section of the plate 1. Two clamps 5 are provided to secure the plate 1 (i.e., set of supplemental handlebars) to a set of primary handlebars 61 by threading. The set of primary handlebars 61 are held in place on a steering post 62 by a clamp 63.

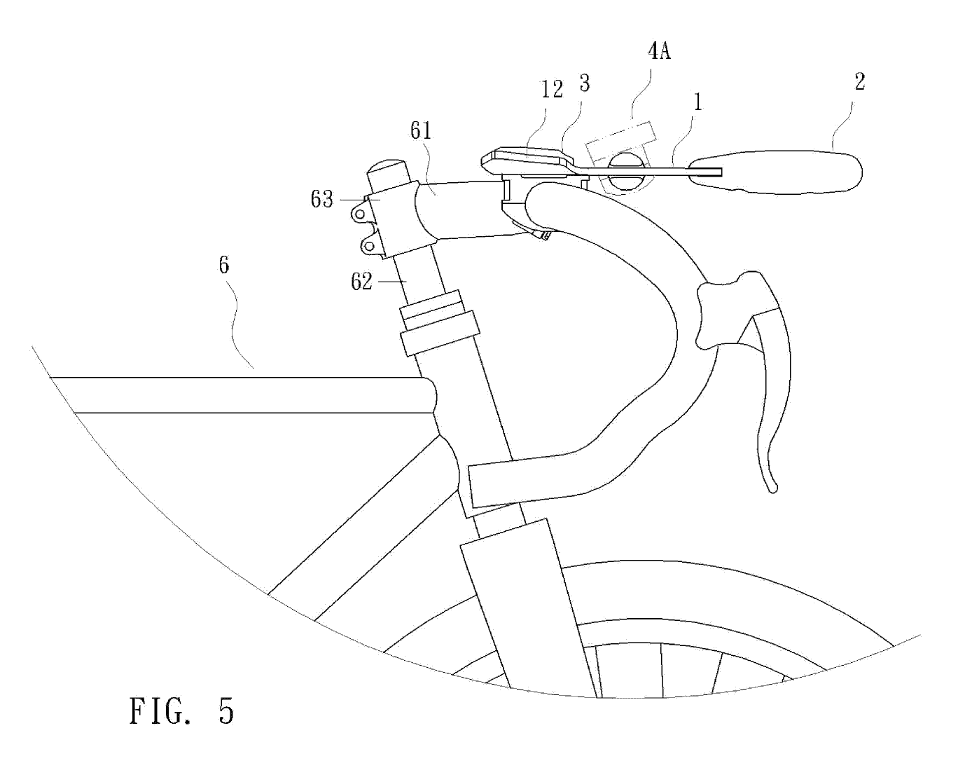

Referring to FIG. 5 specifically, a speedometer 4A is mounted on the speedometer seat.

A person may rest his or her elbows on the pads 3 with his or her hands gripping the handle element 2 in a relatively comfortable riding manner.

Preferably, the plate 1 is made of metal or plastic.

Alternatively, the pads 3 are eliminated in other embodiments.

While the invention herein disclosed has been described by means of specific embodiments, numerous modifications and variations could be made thereto by those skilled in the art without departing from the scope and spirit of the invention set forth in the claims.

What is claimed is:

1. A steering system for a bicycle comprising:
a steering post;
a primary set of handlebars secured to the steering post; and
a supplemental set of handlebars comprising a plate including two forward opposite extensions each having at least one groove, and two rear wings; a U-shaped handle element adjustably secured to the at least one groove by threading; and a clamp for securing the plate to the primary set of handlebars.

2. The steering system of claim 1, further comprising two pads each disposed on the wing.

3. The steering system of claim 1, further comprising a speedometer mounted on the plate.

4. The steering system of claim 1, wherein the number of the at least one groove is two.
